(19) United States
(12) Patent Application Publication
(10) Pub. No.: US 2008/0167935 A1
(43) Pub. Date: Jul. 10, 2008

(54) System and method for identifying and/or for matching labor services via a computer network

(76) Inventor: Sandra Lopez, Hickory Hills, IL (US)

Correspondence Address: PATENTS+TMS, P.C., 2849 W. ARMITAGE AVE., CHICAGO, IL, 60647, US

(21) Appl. No.: 11/649,642

(22) Filed: Jan. 4, 2007

(51) Int. Cl. G06Q 90/00

(52) U.S. Cl. 705/9

(57) ABSTRACT

A system and a method for identifying and/or for matching labor services via a computer network are provided. A laborer uses the computer network to input laborer information into the database. The database is programmed to generate a member number that allows the laborer to identify himself/herself to a contractor and/or to a union. The contractor uses the computer network to review the laborer information in the database to find the laborer to provide a service. The union verifies and/or releases the laborer information of the laborer to be viewed by the contractor. The laborer who is the most productive, the most qualified and/or the most suitable to perform the service for the contractor is more likely to be chosen by the contractor to perform the service.

### BACKGROUND OF THE INVENTION

The present invention generally relates to a system and a method for identifying and/or for matching labor services via a computer network. More specifically, the present invention generally relates to a system and a method for identifying and/or for matching labor services using a database which is accessible via the computer network.

One or more laborers may use the computer network to input laborer information that may be stored in the database. One or more of the laborers may be affiliated with one or more unions. One or more of the laborers may input laborer information related to, for example, a work experience, a certification, a work history, a union affiliation and/or a union number of the laborer. One or more of the unions may verify the laborer information input into the database and/or may release the laborer information to one or more contractors. One or more of the contractors may use the computer network to review the laborer information stored in the database to find one or more of the laborers most productive, most qualified and/or most suitable to perform a service for the contractor. One or more of the contractors may use the computer network to choose one or more of the laborers to perform the service for the contractor. As a result, one or more of the laborers who may be the most productive, the most qualified and/or the most suitable to perform the service for one or more of the contractors may more likely be chosen by one or more of the contractors to perform the service than one or more of the laborers who may be less productive, less qualified and/or less suitable to perform the service.

It is, of course, generally known that laborers may be members of and/or may form labor unions, local unions, trade unions and/or craft unions (hereinafter “labor unions”) for the purpose of maintaining or improving conditions of employment of the laborers. The labor unions provide benefits to insure members against unemployment and/or the like. The labor unions operate openly and/or are recognized by union contractors. The union contractors use the labor unions to employ the members to provide labor services. The labor unions negotiate with the union contractors to improve wages of the members and/or to improve working conditions of the members employed by the union contractors. The members pay recurring dues to the labor unions to become and/or to remain active members of the labor union and, therefore, obtain the benefits provided by the labor unions.

Union contractors contact labor unions to request that laborers be provided to perform services. Labor unions use a rotation system to choose members to send to union contractors that request labor services from the labor unions. Labor unions use the rotation system to choose members who are next available and/or to choose members based upon a bias the labor unions may have toward and/or against the member. As a result, the most productive, the most qualified and/or the most suitable member may not be provided by the labor union to the union contractor to provide the labor services. Further, the labor unions choose members who have not paid dues and/or who may not be active members of the labor union.

Known methods for requesting members for labor services generally involve the placing of a telephone call to a local union to determine if a member is available for one or more positions. Further, known methods involve asking a plurality of questions to a representative of the labor union to determine types of laborers available, qualifications of the laborers and/or other information. These questions are asked of each labor union contacted to determine which union and/or which laborers best suit the needs of the union contractor. Moreover, many times, the labor unions contact the union contractor to gather information about the union contractor and/or the services needed. As a result, labor unions and/or contractors spend more time performing administrative tasks and less time performing the essential tasks of their respective organizations.

Further, it is generally known to provide a website having access to a database wherein the database denotes whether jobs are available at a union contractor site. However, known websites and databases do not provide a mechanism for the union contractor to directly contact the labor unions and/or the members to make appointments, to request services and/or to gather further information about the members available to provide services.

Further, known databases and websites provide no information on a membership status of the members, no qualifications of the members, no employment region of the members, no union number of the members, no availability of a member and/or no availability of open positions with union contractors. Moreover, known databases and websites do not provide access to the database for adding and/or for changing information regarding the labor unions, the members, the union contractors and/or the positions available.

As a result of the rotation system, the union contractors may not review qualifications of members provided by the labor unions for the labor services and/or may not select the members they employ for the labor services. Still further, members selected by the rotation system may be forced to perform services for union contractors in a geographic location outside of a preferred and/or a convenient geographic region of the members. Still further, the most productive, the most qualified and/or the most suitable members are not rewarded with continued employment. Moreover, inefficiencies of the rotation system lead to a growing trend of companies and union contractors taking their business away from labor unions and their members.

A need, therefore, exists for a system and a method for identifying and/or for matching labor services via a computer network. Further, a need exists for a system and a method for identifying and/or for matching labor services using a database which is accessible via the computer network. Still further, a need exists for a system and a method that may allow one or more laborers to use the computer network to input laborer information that may be stored in the database wherein the laborer information may be related to, for example, a work experience, a certification, a work history, a union affiliation, a union member status and/or a union number of the laborer. Still further, a need exists for a system and a method that may allow one or more contractors to use the computer network to review the laborer information that may be stored in the database to find one or more of the laborers most productive, most qualified and/or most suitable to perform a service for the contractor. Still further, a need exists for a system and a method that may allow one or more of the contractors to use the computer network to search for and/or to choose one or more of the laborers to perform the service for the contractor. Moreover, a need exists for a system and a method that may allow one or more of the laborers who may be the most productive, the most qualified and/or the most suitable to perform the service for one or more of the contractors to be more likely chosen by one or more of the contractors to perform the service than one or more of the laborers who may be less productive, less qualified and/or less suitable to perform the service.

### SUMMARY OF THE INVENTION

The present invention generally relates to a system and a method for identifying and/or for matching labor services via a computer network. More specifically, the present invention generally relates to a system and a method for identifying and/or for matching labor services using a database which is accessible via the computer network. One or more laborers may subscribe to the database. One or more of the laborers may use the computer network to input laborer information that may be stored in the database. The laborer information may be, for example, work experience of the laborer, certifications of the laborer, work history of the laborer, union hall of the laborer and/or union number of the laborer. After inputting the laborer information into the database, the database may generate a member number that may allow the laborer to identify himself/herself to one or more contractors and/or one or more unions.

One or more of the contractors may use the network to subscribe to the database. One or more of the contractors may input contractor information into the database. The information may be, for example, a contact name of the contractor, a title of the contact of the contractor, an e-mail address of the contact of the contractor, a company of the contractor, a business address of the contractor and/or a phone number of the contractor. One or more of the contractors may use the database to review the laborer information of one or more of the laborers. One or more contractors may use the computer network to review the laborer information in the database to find one or more of the laborers most productive, most qualified and/or most suitable to perform a service for the contractor. One or more of the contractors may use the computer network to search for and/or to choose one or more of the laborers to perform the service for the contractor. One or more of the contractors may use the database to advertise a company associated with the contractor to one or more users of the database.

One or more of the unions may use the network to subscribe to the database. One or more of the unions may input union information into the database. The union information may be, for example, a contact name of the union, an e-mail address of the contact of the union, a union number of the union, a business address of the union and/or a phone number of the union. One or more of the unions may use the database to advertise to one or more of the laborers and/or to one or more of the contractors.

As a result, one or more of the laborers who may be the most productive, the most qualified and/or the most suitable to perform the service for one or more of the contractors may more likely be chosen by one or more of the contractors to perform the service than one or more of the laborers who may be less productive, less qualified and/or less suitable to perform the service. Moreover, one or more of the unions may verify and/or may release laborer information of the laborers to be viewed by one or more of the contractors.

To this end, in an embodiment of the present invention, a system for matching labor services is provided. The system has a database accessible by a computer network wherein a website is associated with the database wherein the database is accessible to a union, a laborer and a contractor via the website wherein the laborer is a member of the union wherein the contractor is affiliated with the union to employ the member of the union wherein the database is programmed to store laborer information input into the database by the laborer wherein the laborer information is related to a service provided by the laborer wherein the database is programmed to facilitate the union to verify the laborer information wherein the database is programmed to facilitate the contractor to solicit the service of the laborer from the union wherein the database is programmed to facilitate the union to provide access to the laborer information by the contractor. Further, the system has a computer in communication with the database via the computer network wherein the website is accessible by the union, the laborer and the contractor using the computer.

In an embodiment, the computer network is the internet.

In an embodiment, the laborer information is a zip code associated with a geographic area within which the laborer provides the service.

In an embodiment, the database is programmed to facilitate the union to advertise to the contractor an availability of the laborer to provide the service.

In an embodiment, the database is programmed to facilitate the contractor to advertise to the union an existence of a need for the service.

In an embodiment, the database is programmed to facilitate the union to communicate with the laborer.

In an embodiment, the database is programmed to facilitate the laborer to communicate with the contractor.

In another embodiment of the present invention, a method for a method for coordinating labor services is provided. The method has the step of providing a computer network. Further, the method has the step of providing a database accessible via the computer network with a plurality of computers in communication with the database via the computer network. Still further, the method has the step of providing a website associated with the database wherein the database is accessible to a union, a laborer and a contractor via the website wherein the laborer is a member of the union wherein the contractor is affiliated with the union to employ the member of the union. Still further, the method has the step of providing an access to the database via the computer network for using the website. Still further, the method has the step of inputting laborer information into the database via the website wherein the laborer information is related to a service provided by the laborer wherein access to the laborer information by the contractor is restricted.

In an embodiment, the method has the step of searching the database for the laborer information.

In an embodiment, the method has the step of providing a member number to the contractor wherein the member number is associated with the laborer information.

In an embodiment, the method has the step of searching the database for the laborer information using a zip code associated with a geographic area within which the laborer provides the service.

In an embodiment, the method has the step of inputting union information into the database via the website wherein the database is programmed to store the union information input into the database wherein the union information is related to the union.

In an embodiment, the method has the step of soliciting the service of the laborer from the union with the database.

In an embodiment, the method has the step of unrestricting access to the laborer information by the contractor.

In another embodiment of the present invention, a method for identifying labor services is provided. The method has the step of providing a computer network. Further, the method has the step of providing a database accessible via the computer network with a plurality of computers in communication with the database via the computer network. Still further, the method has the step of providing a website associated with the database wherein the database is accessible to a union, a laborer and a contractor via the website wherein the laborer is a member of the union wherein the contractor is unaffiliated with the union to employ the member of the union. Still further, the method has the step of providing an access to the database via the computer network for using the website. Still further, the method has the step of inputting contractor information into the database via the website wherein the database is programmed to store the contractor information input into the database wherein the contractor information is related to a need for the service to be provided. Still further, the method has the step of advertising the need for the service to be provided using the database.

In an embodiment, the method has the step of communicating with the contractor regarding the need for the service to be provided using the database.

In an embodiment, the method has the step of affiliating with the union via the website to employ the member of the union.

In an embodiment, the method has the step of searching the database for the laborer information using a zip code associated with a geographic area covered by the union.

In an embodiment, the method has the step of searching the database for the laborer information using a specialty of the laborer.

In an embodiment, the method has the step of searching the database for the laborer information using a name of the union.

It is, therefore, an advantage of the present invention to provide a system and a method for identifying and/or for matching labor services via a computer network.

A further advantage of the present invention is to provide a system and a method for identifying and/or for matching labor services using a database which is accessible via the computer network.

Another advantage of the present invention is to provide a system and a method for identifying and/or for matching labor services via a computer network that allows one or more laborers to use the computer network to input laborer information into the database.

And, another advantage of the present invention is to provide a system and a method for identifying and/or for matching labor services via a computer network that allows one or more of the laborers to input laborer information into the database wherein the laborer information may be, for example, work experience of the laborer, certifications of the laborer, work history of the laborer, union hall of the laborer and/or union number of the laborer.

Yet another advantage of the present invention is to provide a system and a method for identifying and/or for matching labor services via a computer network wherein the database may generate a member number that may allow the laborer to identify himself/herself to one or more contractors and/or to one or more of the unions.

A further advantage of the present invention is to provide a system and a method for identifying and/or for matching labor services via a computer network that allows one or more of the contractors to use the network to subscribe to the database.

A still further advantage of the present invention is to provide a system and a method for identifying and/or for matching labor services via a computer network that allows one or more of the contractors to input contractor information into the database wherein the contractor information may be, for example, a contact name of the contractor, a title of the contact of the contractor, an e-mail address of the contact of the contractor, a company of the contractor, a business address of the contractor and/or a telephone number of the contractor.

Moreover, an advantage of the present invention is to provide a system and a method for identifying and/or for matching labor services via a computer network that allows one or more of the contractors to use the database to review the laborer information of one or more laborers.

And, another advantage of the present invention is to provide a system and a method for identifying and/or for matching labor services via a computer network that allows one or more of the contractors to use the computer network to review the laborer information stored in the database to find one or more of the laborers most productive, most qualified and/or most suitable to perform a service for the contractor.

Yet another advantage of the present invention is to provide a system and a method for identifying and/or for matching labor services via a computer network that allows one or more of the contractors to use the computer network to search for and/or to choose one or more of the laborers to perform the service for the contractor.

Another advantage of the present invention is to provide a system and a method for identifying and/or for matching labor services via a computer network that allows one or more of the contractors to use the database to advertise a company associated with the contractor to one or more of the laborers who may use the database and/or to one or more of the unions who may use the database.

And, another advantage of the present invention is to provide a system and a method for identifying and/or for matching labor services via a computer network that allows one or more of the unions to use the network to subscribe to the database.

Yet another advantage of the present invention is to provide a system and a method for identifying and/or for matching labor services via a computer network that allows one or more of the unions to input union information into the database wherein the information may be, for example, a contact name of the labor union, an e-mail address of the contact of the labor union, a union number of the labor union, a business address of the union and/or a telephone number of the labor union.

A further advantage of the present invention is to provide a system and a method for identifying and/or for matching labor services via a computer network that allows one or more of the unions to use the database to advertise to one or more of the laborers who may use the database and/or to one or more of the contractors who may use the database.

A still further advantage of the present invention is to provide a system and a method for identifying and/or for matching labor services via a computer network that allows one or more of the unions to verify and/or to release the laborer information to be viewed by one or more of the contractors.

Another advantage of the present invention is to provide a system and a method for identifying and/or for matching labor services via a computer network that centralizes information related to requesting and/or to providing labor services and/or that expedites communications between laborers, unions and/or contractors.

And, another advantage of the present invention is to provide a system and a method for identifying and/or for matching labor services via a computer network that restores respect and pride in unions.

Yet another advantage of the present invention is to provide a system and a method for identifying and/or for matching labor services via a computer network that improves the way contractors and unions work together.

A further advantage of the present invention is to provide a system and a method for identifying and/or for matching labor services via a computer network that restores confidence of one or more of the contractors in one or more of the unions and/or in one or more of the laborers.

Moreover, an advantage of the present invention is to provide a system and a method for identifying and/or for matching labor services via a computer network that ensures the quality of work performed by the laborers, the quality of pay of the labor services and/or the quality of benefits that the laborers receive are not compromised.

Additional features and advantages of the present invention are described in, and will be apparent from, the detailed description of the presently preferred embodiments and from the drawings.

### BRIEF DESCRIPTION OF THE DRAWINGS

FIG. 1 illustrates a diagram of interconnected computers and a database in an embodiment of the present invention.

FIG. 2 illustrates a black box diagram of users identifying and/or matching labor services with a database and information that may be input into the database and/or retrieved from the database in an embodiment of the present invention.

### DETAILED DESCRIPTION OF THE PRESENTLY PREFERRED EMBODIMENTS

The present invention generally relates to a system and a method for identifying and/or for matching labor services via a computer network. More specifically, the present invention generally relates to a system and a method for identifying and/or for matching labor services using a database which is accessible via the computer network. One or more of the laborers may use the computer network to input information about one or more of the laborers into the database. One or more contractors may use the network to subscribe to the database. One or more of the contractors may input information about one or more of the contractors into the database. One or more unions may use the network to subscribe to the database. One or more of the unions may input information about one or more of the unions, about one or more of the laborers and/or about one or more of the contractors into the database. One or more of the contractors may use the database to review the information about one or more of the laborers, about one or more of the unions and/or about one or more of the contractors. Further, one or more of the unions may verify, may release and/or may withdraw information about one or more of the laborers to be viewed by and/or to prevent viewing by one or more of the unions, one or more of the laborers and/or one or more of the contractors.

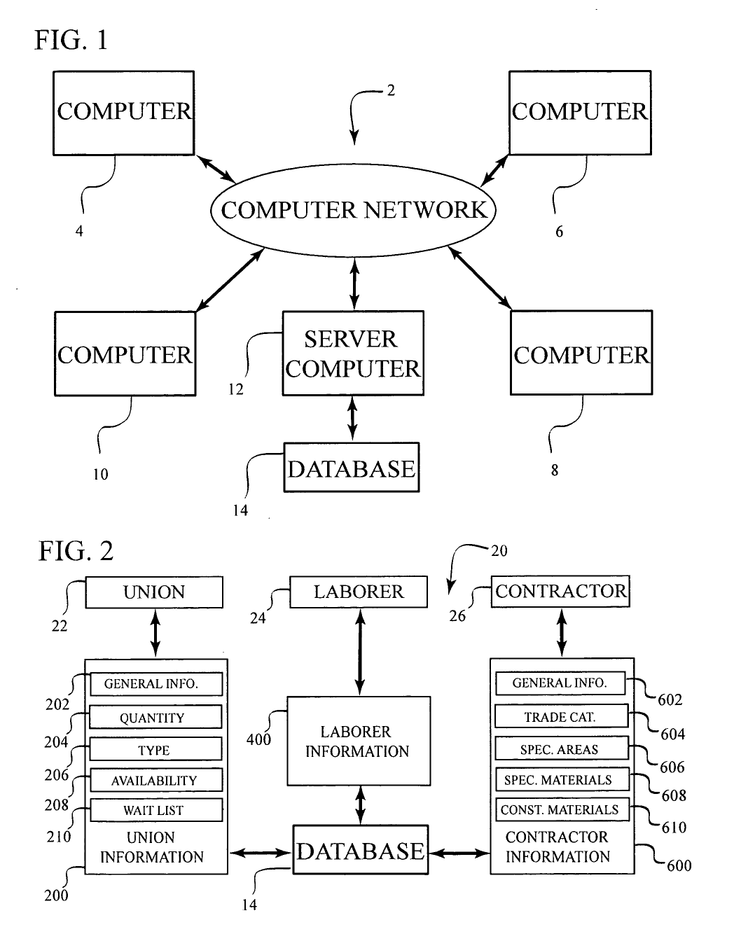

Referring now to the drawings wherein like numerals refer to like parts, FIG. 1 illustrates a computer network 2 having computers 4, 6, 8, 10 connected thereto and in communication therewith. Further, the computer network 2 may have one or more server computers 12 that may be associated with a database 14.

The computer network 2 may be any type of computer network that may interconnect one or more of the computers 4, 6, 8, 10. Of course, any number of computers may be connected to the computer network 2, and the invention should not be construed as limited to a specific number of computers. Further, the computer network 2 may be, for example, the internet wherein remote computers are connected and/or in communication via a telephone network, broadband network, a wireless network or other like network. In addition, the computer network 2 may be an intranet wherein the computers 4, 6, 8, 10 are connected via a network internal to an organization, such as, for example, a business, an institution or the like. For example, the computer network 2 may be connected via a LAN network. However, any computer network may be utilized that may be apparent to those skilled in the art.

The server computer 12 may be associated with and/or in communication with the database 14 associated therewith. The database 14 may contain information input into the database 14 relating to one or more users of the database 14 and/or to one or more websites. One or more of the users may use any of the computers 4, 6, 8, 10 or any other computer connected via the computer network 2 to access the database 14 through the computer network 2. One or more of the users may then enter information into the database 14. One or more users of the database 14 desiring information concerning one or more of the users and/or one or more websites may use any of the computers 4, 6, 8, 10 or any other computer to access the database 14 and/or to extract the information concerning one or more of the users and/or concerning one or more of the websites stored therein. The computer network 2, therefore, may allow for real time updates and/or access to those updates regarding information concerning one or more of the users and/or concerning one or more of the websites.

Further, any of the computers 4, 6, 8, 10 may be a wireless system wherein the computer network 2 may be accessed from a remote location. For example, any of the computers 4, 6, 8, 10 may be a communication device that may access the internet wirelessly. The computers 4, 6, 8, 10 may be, for example, a laptop computer, a handheld computer, a telephone, a personal digital assistant (PDA) and/or the like. Further, any of the computers 4, 6, 8, 10 may be a wireless telephone having access to the internet.

FIG. 2 illustrates a black box diagram of a system 20. The system includes one or more users 22, 24, 26. Further, any users 22, 24, 26 who may access the database 14 may be included in the present invention and is not meant to be limited as herein described.

One or more of the users 22, 24, 26 of the system 20 may be a union 22. Of course, any number of unions 22 may be included in the system 20. The union 22 may be any type of union, such as, for example, a labor union, a trade union and/or the like. Further, any other type of union may be included in the present invention and is not meant to be limited as herein described. one or more of the users 22, 24, 26 of the system 20 may be a laborer 24. Of course, any number of laborers 24 may be included in the system 22. The laborer 24 may be any type of laborer, such as, for example, a carpenter, an HVAC technician, an electrician, a metal fabricator, an excavator, a janitor, a woodworker, a demolitionist, a road construction worker, a roofer, a longshoreman, a landscaper, a mason, an engineer, a painter, a paver, a plumber, a welder, a repairman and/or the like. Further, the laborer 24 may perform a service that may be unionized in a certain geographic area, and/or the laborer 24 may be a member of one or more of the unions 22. Further, any other type of laborer 24 may be included in the present invention and is not meant to be limited as herein described.

One or more of the users 22, 24, 26 of the system 20 may be a contractor 26. Of course, any number of contractors 26 may be included in the system 22. The contractor 26 may be any type of contractor 26, such as, for example, a general contractor, a sub-contractor, a union contractor, a non-union contractor and/or the like. Further, any other type of contractor 26 may be included in the present invention and is not meant to be limited as herein described.

The union 22 may have access to and/or may provide union information 200 to the database 14 for one or more users 22, 24, 26 to access, to view and/or to download. Further, the union 22 may retrieve information from the database 14. The union information 200 may be general union information 202, a quantity of laborers 204 in the union 22, types of laborers in the union 206, a laborer availability projection 208 in the union 22 and whether a wait-list 210 is in effect in the union 22. It should be understood that the union information 200 may be any information about unions as known to one having ordinary skill in the art.

The general union information 202 may be contact information of the union 22, one or more details about the union 22, a geographic area covered by the union 22, an advertisement of the union 22 and/or a history of the union 22. It should be understood that the general union information 202 may be any general information about unions as known to one having ordinary skill in the art.

The quantity of laborers 204 may be the number of laborers 24 who are members of the union 22. The quantity of laborers 204 may be the number of laborers 24 who are active members of the union 22 and/or the number of laborers 24 who are inactive members of the union 22. Of course, other quantities of laborers 22 may be provided by the union 22 that may be apparent to those skilled in the art.

The types of laborers 206 in the union 22 may be, for example, a specialty and/or specialties of one or more of the laborers 24 who are members of the union 22 and/or one or more groups of the laborers 24 who are members of the union 22. Further, the types of laborers 206 in the union 22 may be, for example, a qualification and/or qualifications of one or more of the laborers 24 who are members of the union 22 and/or one or more groups of the laborers 24 who are members of the union 22. Still further, the types of laborers 206 in the union 22 may be, for example, a skill and/or skills of one or more of the laborers 24 who are members of the union 22 and/or one or more groups of the laborers 24 who are members of the union 22. Still further, the type of laborers 206 in the union 22 may be, for example, a work experience and/or work experiences of one or more of the laborers 24 who are members of the union 22 and/or one or more groups of the laborers who are members of the union 22. Of course, other union information 200 related to the types of laborers 22 may be provided by the union 22 to the database 14 that may be apparent to those skilled in the art.

The laborer availability projection 208 may be information concerning the status of available laborers 24 at the union 22. For example, if every laborer 24 of the union 22 is currently employed, the union 22 may provide information that a particular type of laborer 24 may be available within, for example, the following ten days. Of course, the laborer availability projection 208 may be information concerning the availability of laborers 24 for any specified time into the future, such as, for example, days, weeks and/or months into the future.

The wait-list 210 may be information concerning the number of the contractors 26 in line to employ the laborers 24 of the union 22 and/or an estimated time until one or more of the contractors 26 may begin employing laborers 24 of the union 22. For example, if three contractors 26 are on the wait list, the union 22 may provide information that a particular contractor 26 may have the ability to employ laborers 24 of the union 22 within, for example, the following ten days. Of course, the wait list 210 may be information concerning how the particular contractor 26 may have to wait to employ laborers 24 for any specified time into the future such as, for example, days, weeks and/or months into the future.

One or more of the laborers 24 may have access to and/or may provide laborer information 400 to the database 14 for one or more of the users 22, 24, 26 to access, to view and/or to download. Further, one or more of the laborers 24 may retrieve information from the database 14. The laborer information 400 may be, for example, contact information of the laborer 24, work experience of the laborer 24, certifications of the laborer 24, work history of the laborer 24, union 22 of the laborer 24 and/or union number of the laborer 24. After inputting the laborer information 400 into the database 14, the database 14 may generate a member number that may allow the laborer 24 to identify himself/herself to one or more of the unions 22, to one or more of the laborers 24 and/or one or more of the contractors 26. One or more of the laborers 24 may later add to, delete and/or edit the laborer information 400 in the database 14. It should be understood that the laborer information 400 may be any information about laborers as known to one having ordinary skill in the art.

One or more of the contractors 26 may have access to and/or may provide contractor information 600 to the database 14 for one or more of the users 22, 24, 26 to access, to view and/or to download. Further, one or more of the contractors 26 may retrieve information from the database 14. The contractor information 600 may be general contractor information 602, trade categories of the contractor 604, specialty areas of the contractor 606, specialty materials of the contractor 608, construction materials produced by the contractor 610 and/or the like. It should be understood that the contractor information 600 may be any information about contractors as known to one having ordinary skill in the art.

The general contractor information 602 may be, for example, contact information of the contractor 26, details about the contractor 26, a geographic area in which the contractor 26 operates and/or an advertisement of the contractor 26. Further the general contractor information 602 may be, for example, a type of business entity of the contractor 26, a number of project managers of the contractor 26 permanently employed within the last year and/or a number of employees of the contractor 26. Further, the general contractor information 602 may be, for example, a type of the contractor 26, a number of years the contractor 26 has operated, an affiliation of the contractor 26 with a state and/or local government and/or with an agency, an annual income of the contractor 26, an indication as a union contractor and/or a non-union contractor and/or one or more of the unions 22 with which the contractor is a signatory. Further, the general contractor information 602 may be, for example, an insurance capacity of the contractor 26, references of the contractor 26 and/or the like. It should be understood that the general contractor information 602 may be any general information about contractors as known to one having ordinary skill in the art.

The trade categories 604 of the contractor 26 may be, for example, access control systems, access panels, acoustics, drywall, air conditioning, air duct cleaning, alarm systems, architectural metal, electrical, excavating, fencing, fireproofing, flooring, foundation, general contracting, asbestos removal, horizontal boring, vertical boring, building, cleaning and/or power washing. Further, the trade categories 604 may be, for example, cabinets, woodworking, cabling, carpentry, caulking, concrete, demolition, dismantlement, restoration, preservation, road construction, roofing, rubbish removal, sand blasting, water blasting, sewers, metal fabrication, shoring, glass work, glazing, insulation, landscaping, marbling, masonry, mechanical and/or engineering. Further, the trade categories 604 may be, for example, millworking, painting, paving, plastering, plumbing, siding, sprinkler systems, tile, tuckpointing, underground utilities, vacuum waste disposal, waterproofing, welding and/or cutting. It should be understood that the trade categories 604 may be any trade information about contractors as known to one having ordinary skill in the art.

The specialty areas 606 of the contractor 26 may be, for example, aircraft hangars, apartments, assembly areas, atriums, auditoriums, automotive areas, balconies, banks, bars, baseball fields, beverage plants, bus garages, car washes, chain stores, chemical containment areas, chemical plants, churches, clubs and/or commercial constructions. Further, the specialty areas 606 of the contractor 26 may be, for example, commercial kitchens, community buildings, construction trailers, custom homes, hotels, industrial constructions, industrial sites, interiors, laboratories, libraries, locker rooms, malls, marinas, medical facilities, military facilities, multi-family dwellings, municipalities, new constructions, nursing homes, offices, parking garages, parking lots, parks, patios, petroleum plants, playgrounds, processing areas, driveways and/or exteriors. Further, the specialty areas 606 of the contractor 26 may be, for example, factories, food plants, gas stations, golf courses, government facilities, gymnasiums, high traffic areas, highway guardrails, historical buildings, residential dwellings, restaurants, stores, retirement homes, riding arenas, schools and/or shipping docks. Further, the specialty areas 606 of the contractor 26 may be, for example, showrooms, skating rinks, subdivisions, swimming pools, tennis courts, theaters, truck terminals, walk in coolers warehouses, water facilities and/or waste facilities. It should be understood that the specialty areas 606 may be any specialty area information about contractors as known to one having ordinary skill in the art.

The specialty materials 608 of the contractor 26 may be, for example, colors, aluminum, brass, bronze, carpets, ceramics, copper, elastomerics, electrostatics, enamel, fiberglass, galvanized materials, granite, gypsum, hardwood, hollow metals, iron, lacquers, laminates, latex, limestones, marbles and/or metals. Further, the specialty materials 608 of the contractor 26 may be, for example, oil bases, paints, parquet, plastics, polymer concrete toppings, polyurea, slates, solids, stainless steel, stains, steel, synthetics, terrazzo, tile, travertine, varnish, veneers, vinyls, vinylesters, water bases and/or woods. Further, the specialty materials 608 of the contractor 26 may be, for example, zinc, zolatane, natural stones and/or the like. It should be understood that the specialty materials 608 may be any specialty materials of contractors as known to one having ordinary skill in the art.

The construction materials 610 produced by the contractor 26 may be, for example, sands, stones, ready mix, gravel, lime, plastic products, cements, asphalt, wood products, concrete products and/or the like. It should be understood that the construction materials 610 may be any construction materials of contractors as known to one having ordinary skill in the art.

After inputting the contractor information 600 into the database 14, the database 14 may be programmed to generate and/or one or more of the contractors 26 may receive one or more passwords which may allow one or more of the contractors 26 to search for, to access and/or to download the union information 200, the laborer information 400 and/or the contractor information 600. One or more of the contractors 26 may later add to, delete and/or edit the contractor information 600 in the database 14. Further, any other contractor information 600 may be provided by the contractor 26 to the database 14 as may be apparent to those skilled in the art.

The users 22, 24, 26 may have access to the database 14 and may retrieve the union information 200, the laborer information 400 and/or the contractor information 600 from the database 14. The users 22, 24, 26 may include anyone who desires to access, to retrieve and/or to download the union information 200, the laborer information 400 and/or the contractor information 600 from the database 14. The present invention should not be construed as limited as herein described.

Upon receiving the union information 200, the laborer information 400 and/or the contractor information 600 from the database 14, the users 22, 24, 26 may then contact one or more of the unions 22, one or more of the laborers 24 and/or one or more of the contractors 26 through the database 14. Further, the database may be programmed to allow the users 22, 24, 26 to advertise a need for a service, to offer a service and/or to receive a service. Moreover, the users 22, 24, 26 may contact one or more of the unions 22, one or more of the laborers 24 and/or one or more of the contractors 26 through the database 14 for any reason that may be apparent to those skilled in the art.

The database 14 may be web-accessible. Further, the database 14 may be contained on a website or other graphical interface on the computer network that may provide electronic forms for the users 22, 24, 26 to enter information into the database 14 and/or for the users 22, 24, 26 to obtain the information from the database 14. Further, the users 22, 24, 26 may have a website ID number and/or the password to maintain privacy and/or to change and save information input into the database 14 or taken from the database 14. The database 14 may be accessed via a single website or via multiple websites that are linked to the database 14.

In an embodiment, the contractor 26 may desire to find and/or to identify a laborer 24 to provide a service. The contractor 26 may be, for example, a signatory contractor of the union 22. The contractor may search the database 14 for one or more of the laborers 24 that may be active members of the union 22. The contractor 26 may access, may retrieve and/or may download the laborer information 400 related one or more of the laborers 24 who may be active members of the union 22. The contractor 26 may review the contact information of the laborer 24, the work experience of the laborer 24, the certifications of the laborer 24, the work history of the laborer 24, the union 22 of the laborer 24 and/or the union number of the laborer 24. The contact information of the laborer 24, the work experience of the laborer 24, the certifications of the laborer 24, work history of the laborer 24, the union 22 of the laborer 24 and/or union number of the laborer 24 may be associated with the member number of the laborer 24. After reviewing the laborer information 400 of the laborer 24, the contractor 26 may contact the union 22 of the laborer 24 and/or may contact the laborer 24 through the database 14 using the member number of the laborer 24 to invite the laborer 24 to provide the service. The union 22 and/or the laborer 24 may accept the invitation of the contractor 26. The database 14 may be programmed to allow the union 22 and/or the laborer to accept the invitation of the contractor 26. Acceptance of the invitation may result in employment of the laborer 24 with the contractor 26.

In an embodiment, the contractor 26 may desire to find a laborer 24 to provide a service. However, the contractor 26 may not be a signatory contractor of the union 22 and/or may not be familiar with the union 22. The contractor may search the database 14 for one or more of the laborers 24 that may be active members of the union 22 and/or one or more of the unions 22 by inputting a geographic indicator, such as, for example, a zip code associated with an area where the service may be performed. The database 14 may be programmed to provide the contractor 26 with the union information 200 related to the union 22. The contractor 26 may access, may retrieve and/or may download the union information 200 related to one or more of the unions 22. The contractor 26 may review the general union information 202, the quantity of laborers 204 in the union 22, the types of laborers in the union 206, the laborer availability projection 208 in the union 22 and whether a wait-list 210 is in effect in the union 22. After reviewing the union information 200, the contractor 26 may contact the union 22 through the database 14. The database 14 may be programmed to allow the contractor 26 to become a signatory of the union 22 and/or to invite the union to provide and/or to recommend a laborer 24 to provide the service. The union 22 and/or the laborer 24 may accept the invitation of the contractor 26. The database 14 may be programmed to allow the union 22 and/or the laborer 24 to accept the invitation of the contractor 26. Acceptance of the invitation may result in employment of the laborer 24 with the contractor 26.

In an embodiment, the laborer 24 may input the laborer information 400 into the database 14 and/or the database 14 may be programmed to receive the laborer information 400. However, the laborer information 400 may be inaccurate and/or may be false. The database 14 may be programmed to notify the union 22 upon input of the laborer information into the database 14. The union 22 may review and/or may verify the laborer information 400. Further, the union 22 may determine that the laborer 24 has not paid his/her union dues and is, therefore, not an active member of the union 22 and/or may determine that the laborer information 400 is inaccurate. The union 22 may use the database 14 to invite the laborer 24 to become an active member of the union 22 and/or may correct the laborer information 400. Further, in light of the inaccurate laborer information 400, the union 22 may prevent the laborer information 400 from being accessed, from being viewed and/or from being downloaded by the contractor 26 until the laborer information 400 has been corrected. Further, the union 22 may prevent the laborer information 400 from being accessed, from being viewed and/or from being downloaded by the contractor 26 until the laborer has paid his/her union dues.

In an embodiment, the union 22 may use the database 14 to search for laborers 24 who may not be members of the union 22. The union 22 may use the database 14 to invite laborers 24 to become members of the union 22. Further, the laborers 24 may become members of the union 22 using the database 14.

In an embodiment, the contractor 26 may advertise a need for a service to be performed using the database 14. The laborer 24 may find the advertisement using the database 14 and may apply with the contractor 26 using the member number of the laborer 24. The application may be accepted by the contractor 26 that may then lead to the employment of the laborer 24.

In an embodiment, the contractor 26 may search for and/or may find the laborer 24 using the database 14. The contractor 26 may invite the laborer 24 to perform the service by submitting the member number of the laborer 24 to the union 22 through the database 14. The union 22 may verify a union membership of the laborer 24 and/or a union standing of the laborer 24. After the union 22 verifies the union membership of the laborer 24 and/or after the union 22 verifies the union standing of the laborer 24, the union 22 may release the member number of the laborer 24 and/or additional laborer information 400 to the contractor 26 to facilitate employment of the laborer 24 by the contractor 26.

In an embodiment, the union 22, the laborer 24 and/or the contractor 26 may pay a subscription fee to a proprietor of the system 20 to use the database 14 for a limited period of time. The unions 22, the laborers 24 and/or the contractors 26 who have not paid a subscription fee to the proprietor of the system 20 may have restricted access to the database 14, to the union information 200, to the laborer information 400 and/or to the contractor information 600. Therefore, the unions 22, the laborers 24 and/or the contractors 26 who may not have subscribed to the database 14 may not utilize the system 20.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for matching labor services, the system comprising:
a database accessible by a computer network wherein a website is associated with the database wherein the database is accessible to a union, a laborer and a contractor via the website wherein the laborer is a member of the union wherein the contractor is affiliated with the union to employ the member of the union wherein the database is programmed to store laborer information input into the database by the laborer wherein the laborer information is related to a service provided by the laborer wherein the database is programmed to facilitate the union to verify the laborer information wherein the database is programmed to facilitate the contractor to solicit the service of the laborer from the union wherein the database is programmed to facilitate the union to provide access to the laborer information by the contractor; and
a computer in communication with the database via the computer network wherein the website is accessible by the union, the laborer and the contractor using the computer.

2. The system of claim 1 wherein the computer network is the internet.

3. The system of claim 1 wherein the laborer information is a zip code associated with a geographic area within which the laborer provides the service.

4. The system of claim 1 wherein the database is programmed to facilitate the union to advertise to the contractor an availability of the laborer to provide the service.

5. The system of claim 1 wherein the database is programmed to facilitate the contractor to advertise to the union an existence of a need for the service.

6. The system of claim 1 wherein the database is programmed to facilitate the union to communicate with the laborer.

7. The system of claim 1 wherein the database is programmed to facilitate the laborer to communicate with the contractor.

8. A method for coordinating labor services, the method comprising the steps of:
providing a computer network;
providing a database accessible via the computer network with a plurality of computers in communication with the database via the computer network;
providing a website associated with the database wherein the database is accessible to a union, a laborer and a contractor via the website wherein the laborer is a member of the union wherein the contractor is affiliated with the union to employ the member of the union;
providing an access to the database via the computer network for using the website; and
inputting laborer information into the database via the website wherein the laborer information is related to a service provided by the laborer wherein access to the laborer information by the contractor is restricted.

9. The method of claim 8 further comprising the step of:
searching the database for the laborer information.

10. The method of claim 8 further comprising the step of:
providing a member number to the contractor wherein the member number is associated with the laborer information.

11. The method of claim 8 further comprising the step of:
searching the database for the laborer information using a zip code associated with a geographic area within which the laborer provides the service.

12. The method of claim 8 further comprising the step of:
inputting union information into the database via the website wherein the database is programmed to store the union information input into the database wherein the union information is related to the union.

13. The method of claim 8 further comprising the step of:
soliciting the service of the laborer from the union with the database.

14. The method of claim 8 further comprising the step of:
unrestricting access to the laborer information by the contractor.

15. A method for identifying labor services, the method comprising the steps of:
providing a computer network;
providing a database accessible via the computer network with a plurality of computers in communication with the database via the computer network;
providing a website associated with the database wherein the database is accessible to a union, a laborer and a contractor via the website wherein the laborer is a member of the union wherein the contractor is unaffiliated with the union to employ the member of the union;
providing an access to the database via the computer network for using the website;
inputting contractor information into the database via the website wherein the database is programmed to store the contractor information input into the database wherein the contractor information is related to a need for the service to be provided; and
advertising the need for the service to be provided using the database.

16. The method of claim 15 further comprising the step of:
communicating with the contractor regarding the need for the service to be provided using the database.

17. The method of claim 15 further comprising the step of:
affiliating with the union via the website to employ the member of the union.

18. The method of claim 15 further comprising the step of:
searching the database for the laborer information using a zip code associated with a geographic area covered by the union.

19. The method of claim 15 further comprising the step of:
searching the database for the laborer information using a specialty of the laborer.

20. The method of claim 15 further comprising the step of:
searching the database for the laborer information using a name of the union.
